(19) United States
(12) Patent Application Publication
(10) Pub. No.: US 2012/0109710 A1
(43) Pub. Date: May 3, 2012

(54) RETAIL TIME TO EVENT SCORECARDS INCORPORATING CLICKSTREAM DATA

(75) Inventors: Shafi Ur Rahman, Bangalore (IN); Amit Kiran Sowani, Mumbai (IN); Rakhi Agrawal, Pantnagar (IN)

(73) Assignee: FAIR ISAAC CORPORATION

(21) Appl. No.: 12/913,185

(22) Filed: Oct. 27, 2010

(51) Int. Cl. G06F 17/30

(52) U.S. Cl. 705/7.31

(57) ABSTRACT

The current subject matter provides the ability to infer a richer customer profile using clickstream data obtained in connection with the traversal of a website by a customer. In some cases, this clickstream data is used in connection with in-store point of sale data and inputted into a Time to Event scorecard model in order to identify transactions (e.g., offerings, campaigns, etc.) to be initiated. Related apparatus, systems, techniques and articles are also described.

### TECHNICAL FIELD

The subject matter described herein relates to techniques for used customer clickstream data obtained while the customer traverses a website into targeted offerings/transactions.

### BACKGROUND

Customer actions while traversing a website are often disregarded unless they ultimately result in the purchase of a product or service. However, such information when captured and properly characterized can provide more insight into a customer as compared to in-store point of sales information.

### SUMMARY

In a first aspect, clickstream data is recorded that characterizes a customer browsing through available products and services on a website. Thereafter, one or more clickstream variables are derived from the recorded clickstream data. The derived clickstream variables are inputted into or otherwise utilized by a Time to Event scorecard model to characterize a likelihood of the customer to undertake a future purchasing activity. Subsequently, one or more transactions can be initiated using the output of the Time to Event scorecard model.

The Time to Event scorecard model can also use other information relating to the clickstream data. For example, the clickstream data can be used to compute website recency and frequency variables which respectively characterize a time interval between visits by the customer to the website and a number of all web pages visited by the customer during a particular website visit. These variables can be used in conjunction with in-store recency and frequency variables which in turn respectively characterize a time interval between purchases by customers of a particular product, and the number of all products purchased during a particular in-store visit. These variables can be aggregated, and in some cases, aggregated using the same time-discretized intervals (in order to make comparisons easier and to distinguish between separate website related events by the customer). All or some of the variables can be processed using a variable selection algorithm to optimize a likelihood of success of the transactions. Other information can also be used by the variable selection algorithm and/or the Time to Event scorecard model including customer, demographic data (and/or identified groups based on such demographic data).

Articles of manufacture are also described that comprise computer executable instructions permanently stored (e.g., non-transitorily stored, etc.) on computer readable media, which, when executed by a computer, causes the computer to perform operations herein. Similarly, computer systems are also described that may include a processor and a memory coupled to the processor. The memory may temporarily or permanently store one or more programs that cause the processor to perform one or more of the operations described herein. Computer-implemented methods as described herein can include methods in which operations are implemented by one or more data processors (which may be unitary or distributed across two or more computing systems).

The subject matter described herein provides many advantages. By providing the ability to infer or derive greater user profiling information based on clickstream data (which is separate from purchase data), more informed decisions can be generated. This in turn can result in a greater return on investment of companies adopting the current subject matter. Moreover, the current subject matter is advantageous in that is provides the ability to characterize the trajectory of a particular consumer prior to making a purchase online.

In addition, the current subject matter enables an increase in the predictive power of utilized models due to reduction in data fragmentation. In addition, this in turn can lead to an increased ROI for companies making product offers. For example, personalized online recommendations can help in increasing customer loyalty. The use of clickstream data as described herein can help predict the propensity of customers to visit a webpage which can be used to generate customer specific webpage recommendations.

The details of one or more variations of the subject matter described herein are set forth in the accompanying drawings and the description below. Other features and advantages of the subject matter described herein will be apparent from the description and drawings, and from the claims.

### DESCRIPTION OF DRAWING

FIG. 1 is a process flow diagram illustrating the use of clickstream data variables in a Time to Event scorecard model.

### DETAILED DESCRIPTION

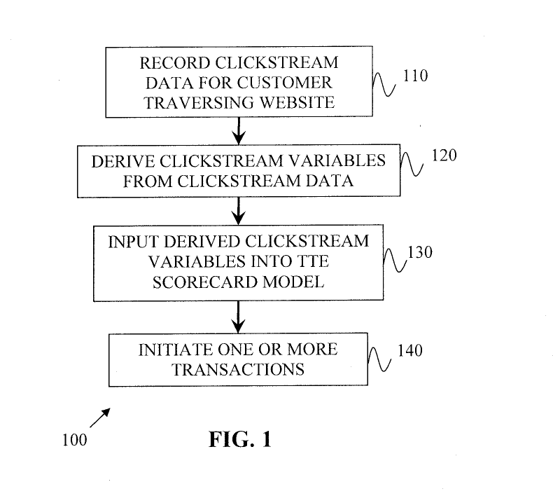

FIG. 1 is a process flow diagram illustrating a method 100 in which, at 110, clickstream data is recorded that characterizes a customer browsing through available products and services on a website. Thereafter, at 120, one or more clickstream variables are derived from the recorded clickstream data. The derived clickstream variables are inputted, at 130, into a Time to Event scorecard model to characterize a likelihood of the customer to undertake a future purchasing activity. Subsequently, at 140, one or more transactions can be initiated using the output of the Time to Event scorecard model.

The current subject matter can be used in connection with retail marketing systems having a decisioning capability (e.g., real-time or near real-time decisioning capability) that combines a data mining algorithm that adjusts predictions based on the success of previous predictions and a rules engine that arbitrates among possible recommendations based on the enterprise's strategic priorities. This decisioning capability can be informed by analytics, to decide the next best offering to be made to a customer based on their profile (which can be based, in part, on their purchase history and/or their clickstream data).

Purchase data along with customer demographic information (collectively customer profiling data) can be used to predict future propensities of customers for buying various products. Often multiple Stock Keeping Units (SKUs) can be grouped together at a more appropriate level to reduce data fragmentation. SKU information can be grouped at this hierarchical level for computing models that predict an individual customer's propensity to buy corresponding products. Time to Event (TTE) scorecard models can be created for each item at that hierarchical level (for example, see, U.S. patent application Ser. No. 12/197,134 published as U.S. Pat. App. Pub. No. 2010/0049538, the contents of which are hereby fully incorporated by reference). Purchase data can be used to compute characteristics representing how recently and how frequently each of the products are purchased. This information along with customer demographic data can be processed through, for example, a variable selection algorithm to select the most effective characteristics for each TTE scorecard model.

The current subject matter provides for an additional dataset, generated by online browsing behavior of customers, to enhance performance of Time to Event (TTE) scorecards which in turn improves product purchase propensity predictions. These improvements are accomplished by computing an additional set of a large number of powerful characteristics based on the new dataset (apart from the existing characteristics).

In addition to traditional retail outlets, companies offer their goods and services through online sales portals (e.g., websites, mobile applications, etc.). As used herein, the phrase “clickstream data” characterizes data that is generated by customers browsing through available products on such online sales portals. The information related to the sequence of “clicks” can be recorded by the retailer's web servers (or by third party pixel-based tracking solutions, etc.) on the sales portal. Clickstream data can contain a multitude of information which can be used to further enhance an understanding of customer purchase patterns. Table 1 illustrates a sample click stream database:

TABLE 1

| customer | | | purchase | session purchase | previous page |
|---|---|---|---|---|---|
| id | date time | Sku | tag | tag | visit |
| 100001 | 10/25/2010 3:55:41 PM | 11223344 | 0 | 1 | null |
| 100001 | 10/25/2010 3:58:36 PM | 22334455 | 1 | 1 | 11223344 |
| 100002 | 10/24/2010 2:55:41 PM | 33445566 | 0 | 0 | null |
| 100002 | 10/24/2010 3:08:36 PM | 55667788 | 0 | 0 | 33445566 |
| 100002 | 10/25/2010 3:58:36 PM | 66778899 | 0 | 0 | null |

The current subject matter can consume the first four columns of Table 1 (i.e, the customer id, the date and time, the SKU and the purchase tag. By analyzing this clickstream data, \the trajectory of the customer can be captured as well as their intention to purchase a product (even if no purchase is ultimately consummated). Path data may contain information that can be used to derive a user's goals, knowledge, and interests (based on historical purchase patterns of the customer as well as other customers). Path data can include browsing history, click patterns, and other indicators which can characterize user behavior other than purchasing a product. For instance, this data can log that a particular user started at the home page and executed a search for a particular product, selected the first item in the search list that took her to a product page with detailed information about the product, and whether or not she purchased the SKU. Alternatively, a log can indicate that another user arrived at the home page, went to the product category list, browsed through a list of SKUs, repeatedly backing up and reviewing the pages and finally purchased a particular SKU or not.

The current subject matter makes use of the information generated by online browsing behavior of the customers by inferring new variables based on the clickstream data source and incorporating it within the existing software framework. Based on this enhanced framework new variables can be utilized in the models to improve model predictions of future product purchase.

Time to event (TTE) scorecard models already include a rich set of characteristics that capture relevant details about customers that lead to purchase of various products. These characteristics are broadly grouped into three distinct categories: a) seasonality, b) static demographic information pertaining to the customer and most importantly c) dynamic purchase pattern of the said customer. The dynamic purchase pattern is a rich set of customer characteristics representing customer's purchase behavior that capture how recently and how frequently various products were purchased. A time to event scorecard model is used to capture the interactions between characteristics accurately to compute individual purchase propensity of the targeted product. The frequency of past purchases is positively related to a customer's future buying behavior. The time elapsed from the last purchase is an indicator for future buying patterns. Customers who recently purchased are more likely to be active than customers who shopped a long time ago. The framework also processes demographic variables of customers, especially for products whose purchase is driven by a particular demographic.

It is notable, that in-store point of sale data is not a good indicator of the intent of a customer to buy a particular product. To determine individual purchase probabilities clickstream data is taken into account in addition to customer demographics and past purchase behavior; in order to maximize the predictive power of our models.

As an example, customers browse through several products before selecting a product for a store purchases, however it is not possible to track these browsing patterns. These browsing patterns can be gauged through the online clicking patterns of customers (which can be monitored directly by the hosting website via one or more tracking modules or which may be monitored by a remote web service having tracking pixels embedded on relevant webpages) for whom there is clickstream data. The clickstream variables can be used in a fashion similar to recency and frequency variables which are generated in the TTE framework. Recency and frequency of page visits of each product is computed at a desired level of product hierarchy.

Clickstream session information can be aggregated at discretized time intervals. This discretized time interval is referred to as a trend and it helps to avoid data fragmentation and to be consistent with the point of sale data discretization. Using a very small time interval is likely to treat two related web browsing activity separately. A very big time interval would lose the causal relationship between a visit and eventual purchase as the purchase or lack thereof should be recorded in subsequent intervals. Keeping the time interval same as the interval used for point of sale data allows us to treat the two time-discretized data sets in unison. The frequency and recency of the visits can have similar influence on the purchase patterns as do the TTE purchase frequency and recency variables. Aggregated variables representing all past page views are also computed. Aggregated frequency variable is the summation of the counts of all the pages clicked. This aggregated variable allows an insight into the seriousness of a customer's requirements—for example, more number of overall page clicks might indicate a seriousness to identify the right product. Aggregated recency variable indicates how recently the customer clicked on any product page. It indicates the customer's engagement on the online sales portal.

Online purchases can be treated in the similar manner as the in-store purchases. Recency and frequency of product purchase are computed as characteristics for the models.

In order to incorporate the clickstream data, visit variables can be created corresponding to each stock keeping unit (SKU). The transaction data in retail domain contains one entry for each SKU purchased by a customer on a given date, which is called a line item. Typically, for creating models, an appropriate hierarchical level is chosen from retailers SKU hierarchy and SKU is mapped to this level. Customer profiles are then generated using this mapped data. Similarly, click stream data in retail contains one entry for each SKU page view. If the page visit corresponds to a purchase of the product, then typically a purchase indicator flag is set to 1 in the click stream data. When the purchase indicator flag is set to 1, then SKU is mapped to the appropriate level of product hierarchy to indicate the purchase of the product, just like in case of line item data. The SKU of each click stream entry, irrespective of the purchase indicator, is mapped to the appropriate level of product hierarchy and a visit indicator, “V”, is prefixed to the product id to differentiate it from a purchase of the product. These visit variables act as “virtual” products. These “virtual” products can then used to compute characteristics representing how recently and how frequently each of the “virtual” products are visited online. The following table illustrates the transformation of the click stream lines containing SKUs to the virtual line items:

TABLE 2

| Click Stream | | | Virtual | |
|---|---|---|---|---|
| Data (as SKU | Purchase | | Line | Meaning of virtual |
| level) | Indicator | Subcategory | Items | product |
| 11223344 | 0 | 1234 | V1234 | page view of 1234 |
| 22334455 | 1 | 2345 | 2345 | purchase of 2345 |
| | | | V2345 | page view of 2345 |

These “virtual” products can be used to compute predictor characteristics for enhancing the TTE models. The recency and frequency of all the products including the virtual visit products is computed. Purchase of a targeted product can depend on the recency and frequency of purchase of other or same products. Further, it can depend on the recency and frequency of page visits of other or same products as well. The computed characteristics are processed using a variable selection algorithm to optimize the likelihood of success of purchase of a desired product. The variable selection algorithm can be trained with combinations of the characteristics and resulting divergences are computed such that combinations of the characteristics having a divergence above a pre-defined threshold are utilized for a final TTE model for the desired product whose purchase propensity needs to be predicted. This approach allows for minimal changes in the TTE modeling framework while providing a broad set of very powerful characteristics.

The standalone point of sale data is a fragmented piece of data, due to lack of online purchase data. The online purchase which was initially unseen to the TTE model was treated as a non purchase there by giving the model a wrong signal. By aggregating the clickstream data with the point of sale data the problem of data fragmentation is reduced.

Within the TTE framework, models can be created for various electronic items. Customers tend to browse online to compare various products before purchasing these electronic items in the store. With the inclusion of the clickstream data this trend can be captured resulting in better prediction of the customer's propensity to purchase the item. For example, the purchase of GPS navigation system is often preceded by an extensive online research of the various options and features of various models of this product. Access to click stream data allows to capture the predictive relationship between the recency and frequency of page visits of the GPS navigation system and the eventual purchase of the product. Similarly, for a high end LCD TV, the recency and frequency of page visits of the TV informs the ability to predict the purchase of the said product.

The current subject matter is also related to co-pending application Ser. No. 12/890,332 filed Sep. 24, 2010 and entitled: “MULTI-HIERARCHICAL CUSTOMER AND PRODUCT PROFILING FOR ENHANCED RETAIL OFFERINGS”, the contents of which are hereby fully incorporated by reference.

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

Although a few variations have been described in detail above, other modifications are possible. For example, the logic flow depicted in the accompanying figures and described herein do not require the particular order shown, or sequential order, to achieve desirable results. In addition, the skilled artisan will appreciate that references to products include services and other actions (unless otherwise explicitly stated). Other embodiments may be within the scope of the following claims.

What is claimed is:

1. A method for implementation by one or more data processors comprising:
deriving one or more clickstream variables from recorded clickstream data, the recorded clickstream data characterizing a customer browsing through available products and services on a website;
inputting the derived clickstream variables into a Time to Event scorecard model to characterize a likelihood of the customer to undertake a future purchasing activity; and
initiating one or more transactions using output of the Time to Event scorecard model.

2. A method as in claim 1, further comprising:
computing website recency variables based on a time interval between visits by the customer to any web page; and
wherein the website recency variables are inputted into the Time to Event scorecard model.

3. A method as in claim 2, further comprising:
computing website frequency variables based a number of all web pages visited by the customer during a particular website visit; and
wherein the website frequency variables are inputted into the Time to Event scorecard model.

4. A method as in claim 3, further comprising:
computing in-store recency variables based on a time interval between purchases by customers of a particular product; and
wherein the in-store recency variables are inputted into the Time to Event scorecard model.

5. A method as in claim 4, further comprising:
computing in-store frequency variables based a number of all products purchased during a particular in-store visit; and
wherein the in-store frequency variables are inputted into the Time to Event scorecard model.

6. A method as in claim 5, further comprising: aggregating the website frequency and recency variables at discretized time intervals.

7. A method as in claim 6, wherein the in-store purchase frequency and recency variables are discretized at the same time intervals as the website frequency and recency variables.

8. A method as in claim 7, further comprising:
processing the derived clickstream variables, website frequency and recency variables, in-store frequency and recency variables using a variable selection algorithm to optimize a likelihood of success of the transactions.

9. A method as in claim 1, further comprising:
accessing demographic data for the customer; and
wherein the demographic data is also inputted into the Time to Event scorecard model.

10. A method as in claim 1, wherein each product has a corresponding stock keeping unit (SKU), and wherein visit variables are created corresponding to each SKU, wherein the visit variables are used to generate a website line item for the SKU.

11. An article comprising a non-transitory storage medium embodying instructions which when executed by a data processor result in operations comprising:
recording clickstream data that characterizes a customer browsing through available products and services on a website;
deriving one or more clickstream variables from the recorded clickstream data;
inputting the derived clickstream variables into a Time to Event scorecard model to characterize a likelihood of the customer to undertake a future purchasing activity; and
initiating one or more transactions using output of the Time to Event scorecard model.

12. An article as in claim 11, wherein the operations further comprise:
computing website recency variables based on a time interval between visits by the customer to any web page; and
wherein the website recency variables are inputted into the Time to Event scorecard model.

13. An article as in claim 12, wherein the operations further comprise:
computing website frequency variables based a number of all web pages visited by the customer during a particular website visit; and
wherein the website frequency variables are inputted into the Time to Event scorecard model.

14. An article as in claim 13, wherein the operations further comprise:
computing in-store recency variables based on a time interval between purchases by customers of a particular product; and
wherein the in-store recency variables are inputted into the Time to Event scorecard model.

15. An article as in claim 14, wherein the operations further comprise:
computing in-store frequency variables based a number of all products purchased during a particular in-store visit; and
wherein the in-store frequency variables are inputted into the Time to Event scorecard model.

16. An article as in claim 15, wherein the operations further comprise:
aggregating the website frequency and recency variables at discretized time intervals.

17. An article as in claim 16, wherein the in-store purchase frequency and recency variables are discretized at the same time intervals as the website frequency and recency variables.

18. An article as in claim 17, wherein the operations further comprise:
processing the derived clickstream variables, website frequency and recency variables, in-store frequency and recency variables using a variable selection algorithm to optimize a likelihood of success of the transactions.

19. An article as in claim 18, wherein the operations further comprise:
accessing demographic data for the customer; and
wherein the demographic data is also inputted into the Time to Event scorecard model.

20. An article as in claim 11, wherein each product has a corresponding stock keeping unit (SKU), and wherein visit variables are created corresponding to each SKU, wherein the visit variables are used to generate a website line item for the SKU.
